(19) United States
(12) Patent Application Publication
(10) Pub. No.: US 2011/0235460 A1
(43) Pub. Date: Sep. 29, 2011

(54) METHOD AND APPARATUS TO OPTIMIZE THE MIXING PROCESS

(75) Inventor: Joel Rondeau, Antony (FR)

(73) Assignee: Schlumberger Technology Corporation, Sugar Land, TX (US)

(21) Appl. No.: 13/084,051

(22) Filed: Apr. 11, 2011

Related U.S. Application Data
(63) Continuation-in-part of application No. 11/996,087, filed on Jan. 18, 2008.

(30) Foreign Application Priority Data
Jul. 22, 2005 (EP) 05291577.4

(51) Int. Cl. B28C 7/04; B28C 5/46

(52) U.S. Cl. 366/6; 366/30; 366/31

(57) ABSTRACT

A system for mixing a liquid material and a solid material comprises (i) a base unit for the liquid material and the solid material; (ii) a liquid material supply; (iii) a solid material supply; (iv) a liquid/solid mixing output; (v) an injection unit connected to the liquid material supply and to the solid material supply and the injection unit injecting the liquid material and the solid material in the base unit; (vi) a separation and extraction unit simultaneously separating and extracting surplus gas arising from the mixing of the liquid material and the solid material.

### CROSS-REFERENCED APPLICATIONS

This application is a Continuation in Part of U.S. patent application Ser. No. 11/996,087 that entered the US on Jan. 18, 2008 from international application PCT/WO2007/009567 filed on Jun. 29, 2006 claiming the benefit of EP priority application 05291577.4 filed on Jul. 22, 2005; all incorporated by reference in their entirety.

### BACKGROUND

The present disclosure broadly relates to mixing systems. More particularly, the disclosure relates to an apparatus and related method for mixing a liquid material and a solid material to obtain a pumpable slurry in a timely, cost-effective and efficient manner. The apparatus removes surplus gas or air in the solid/liquid mixing, thereby improving the mixing process. In particular, this disclosure provides a system for the continuous mixing of cement slurries or other fluids used in the drilling, completion or stimulation of boreholes such as oil or gas wells.

When a well such as an oil or gas well has been drilled, it is often desired to isolate the various producing zones from each other or from the well itself in order to stabilize the well or prevent fluid communication between the zones or shut off unwanted fluid production such as water. This isolation is typically achieved by installing a tubular casing in the well and filling the annulus between the outside of the casing and the wall of the well (the formation) with cement. The cement is usually placed in the annulus by pumping slurry of the cement down the casing such that it exits at the bottom of the well and passes back up the outside of the casing to fill the annulus. Sometimes, however, the cement slurry is pumped down the annulus from the surface—a procedure known as “reverse cementing.” While it is possible to mix the cement slurry as a batch prior to pumping into the well, it has become desirable to effect continuous and optimized mixing of the cement slurry at the surface just prior to pumping into the well. This has been found to provide better control of cement properties and more efficient use of materials.

The cement slurries used in such operations comprise a mixture of dry solids and liquid materials. The liquid phase is typically aqueous-base and may have chemical additives dissolved or dispersed therein. The solids typically comprise dry cement and may further comprise solid chemical additives blended therein.

FIGS. 1 and 2 show a schematic diagram of a prior art mixing system. In FIG. 1, solid materials are delivered to the mixer 10 directly from a surge can 8 via a flow control valve 6 and are carried into the mixing tub 5 with the mix water. The water is delivered via a first water supply 1, and optionally via a second water supply 7 when the amount of water can not be efficiently delivered via the first supply 1 for pressure and flow-rate problems. The contents of the mixing tub 5 are recirculated with a pump 4, generally a centrifugal pump, through a recirculation pipe 11 to the mixer 10 via a recirculation input 2. An output 3 is provided for slurry to be pumped into the well. In FIG. 2, solid materials are delivered to the mixer 10 from a silo via a direct feeding 18 controlled by a flow control valve 16 and are carried into the mixing tub 5 with the mix water. The other parts of the mixing system of FIG. 2 are similar to those of the mixing system of FIG. 1. U.S. Pat. No. 4,007,921 discloses such a type of mixer for mixing dry particles with a liquid.

Actually, when using prior-art mixing systems, the mixing process may not be efficient. Problems may occur when mixing a solid component and a liquid component—the resulting slurry contains a surplus of gas that interferes with the mixing process. The solids are in granular or powder form, and air is present within the interstitial voids. The solids may also be fluidized with air to improve flowability and transportability to the mixer, especially when stored in a silo. This entrapped air frequently becomes a serious problem when the liquid and solid components are mixed. Entrapped air interferes with the centrifugal pump, decreasing its performance and therefore the performance of the entire mixing system.

The present disclosure seeks to provide a mixing system that avoids the cited problems.

### SUMMARY

In an aspect, embodiments relate to a system for mixing a liquid material and a solid material, the system comprising: (i) a base unit, for the liquid material and the solid material; (ii) a liquid material supply; (iii) a solid material supply; (iv) a liquid/solid mixing output; (v) an injection unit connected to the liquid material supply and to the solid material supply, the injection unit injecting the liquid material and the solid material in the base unit; (vi) a separation and extraction unit that simultaneously separates and extracts surplus gas from the base unit. The surplus gas arises from the mixing of the liquid material and the solid material.

Preferably, the mixing system further comprises an extraction unit connected to the liquid/solid mixing output, from which a liquid/solid mixture exits that is substantially gas free.

Preferably, the base unit ensures the mixing of the liquid material and the solid material. More preferably, the base unit is a base cyclic unit ensuring recirculation of the liquid material and the solid material through a recirculation input in the injection means. The base cyclic unit therefore ensures the mixing of the liquid material and the solid material. The recirculation improves the efficiency of the mixing process and avoids wasting imperfectly mixed slurry.

In preferred embodiments, the system applies to a cement slurry—the liquid material being an aqueous solution or suspension (water, solid additives, other liquid additives) and the solid material comprising dry cement and, optionally, solid additives blended therein.

Preferably, the separation and extraction unit is a conical cyclonic unit, preferably of the type commonly known as a hydrocyclone. The cyclonic unit ensures efficient and rapid separation and extraction of gas from the slurry. The cyclonic unit is further resistant to problems of corrosion arising from the use of abrasive components, or of erosion arising from the movement of solid components at a high speed. The separation and extraction unit may further comprise a gas-surplus output, the gas-surplus output being connected to the surrounding atmosphere. No pressure equalization is necessary, because the gas will automatically vent to the atmosphere.

Preferably, the injection unit further comprises the function of pre-mixing the liquid material and the solid material. More preferably, the injection unit is an injector with three nozzles coming respectively from the solid material supply, the liquid material supply, and the recirculation input, the first and second nozzles allowing a first mixing before a second mixing with the third nozzle. Preferably, the solid material enters at an angle substantially perpendicular to the liquid material, allowing a first mixing. The recirculation input is positioned parallel to and below the liquid material supply, so that the slurry coming from the recirculation input is mixed with the liquid material and the solid material after the first mixing. This configuration is suitable to ensure mixing in a cost- and time-efficient manner. This injection unit is further resistant to problems of corrosion arising from the use of abrasive components, or of erosion arising from the movement of solid components at a high speed.

In preferred embodiments, the system further comprises a control system controlling the solid material supply; said control system being located at a distance sufficiently great from the injection unit to remain substantially dry. Preferably, the distance is sufficiently great to avoid splash from the mixer. The distance is preferably several centimeters—preferably more than 5 centimeters, more preferably more than 10 centimeters, and most preferably more than 20 centimeters—depending on the diameter of the solid-material-supply opening to the mixer. The distance-to-diameter ratio is preferably greater than 2, more preferably greater than 5 and most preferably greater than 10. Maintaining a sufficiently long distance is ensured by a tube, preferably transparent and/or flexible and/or sufficiently vacuum resistant, that is located between the control means and the injection unit. The tube may further comprise a pressure valve located between the control system and the injection unit. The pressure valve or vacuum breaker ensures that the mixer is not depressurized when the flow control valve is closed, and that the pressure inside the tube remains substantially the same. The tube is also free of solid material thanks to the pressure valve. The control system is preferably a knife gate, which ensures a constant and repeatable flow rate of the solid material.

In further preferred embodiments, the system further comprises a perturbing system enhancing the delivery of the solid material, the perturbing system being located between the solid material supply and the injection unit. The perturbing system is any one of the systems taken in the list comprising pneumatic vibration systems, mechanical vibration systems, acoustic vibration systems, piezoelectric vibration systems and electromagnetic vibration systems.

In further aspects, embodiments relate to methods for mixing a liquid material and a solid material, the method comprising: (i) mixing the liquid material and the solid material to form a liquid/solid slurry; (ii) simultaneously separating and extracting surplus gas from the liquid/solid slurry that arises from the mixing of the liquid material and the solid material; and (iii) extracting from said liquid/solid slurry a liquid/solid material substantially without gas.

The method may further comprise a recirculation step, wherein the liquid/solid slurry not extracted in step (iii) is re-injected in the liquid/solid slurry of step (i). The recirculation ensures a more efficient mixing process and avoids wasting imperfectly mixed slurry.

The method may apply to mixing a cement slurry, the liquid material being an aqueous solution or suspension and the solid material being cement, the cement optionally containing solid additives blended therein.

The step (ii) of simultaneously separating and extracting surplus gas is accomplished by a conical cyclonic effect. The cyclonic effect ensures efficient and rapid extraction of gas from the slurry. The cyclonic effect is further independent of or resistant to corrosion problems arising from the use of abrasive components or of erosion arising from the movement of solid components at a high speed.

The method may further comprise a step of pre-mixing the liquid material and the solid material before the step (i) of mixing the liquid material and the solid material. Also, the step of pre-mixing the liquid material and the solid material may comprise a vibration step to enhance delivery of the solid material.

### BRIEF DESCRIPTION OF THE DRAWINGS

Embodiments of the present disclosure may be understood with the appended drawings.

FIG. 1 shows a schematic diagram of a mixing system with a surge can of solid material supply from Prior Art.

FIG. 2 shows a schematic diagram of a mixing system with a silo for solid material supply from Prior Art.

FIG. 3 shows a mixer from Prior Art.

FIG. 4 shows a schematic diagram of the mixing system according to the present disclosure

FIG. 5 shows a schematic diagram of a mixing system with a surge can of solid material supply.

FIG. 6 shows a schematic view of the principle of the gas/liquid/solid separation.

FIG. 7 shows a schematic diagram of a mixing system with a silo for solid material supply.

### DETAILED DESCRIPTION

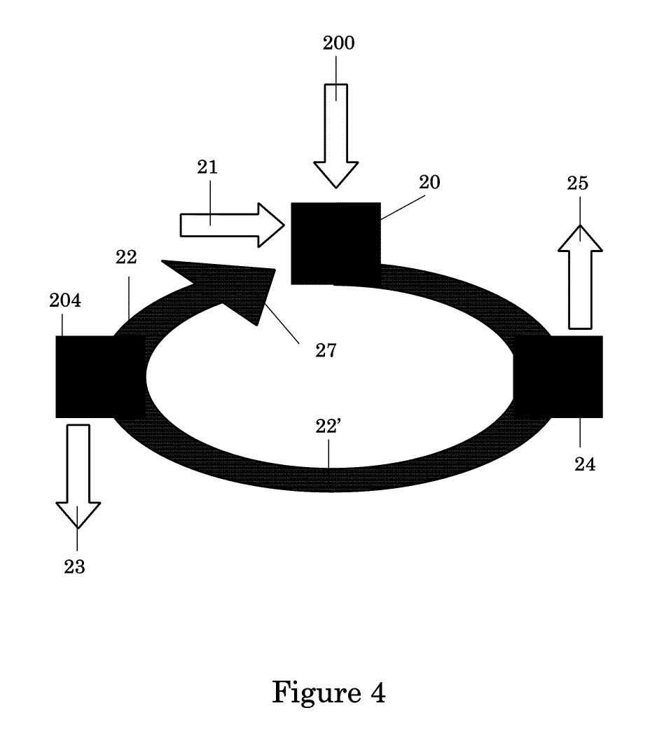

In an aspect, embodiments relate to a system for mixing a liquid material and a solid material. FIG. 4 is a schematic diagram of the mixing system according to the present disclosure. The major improvement in the proposed mixing system is to eliminate the problem of surplus gas in the mixing process, by removing substantially all of the gas present in the liquid/solid slurry. The mixing system comprises a base unit 22′ wherein the liquid material and the solid material may be mixed; a liquid material supply 21; a solid material supply 200; an injection unit 20 connected to the liquid material supply and to the solid material supply and injecting the liquid material and the solid material in the base unit; an separation and extraction unit 24 simultaneously separating and extracting from the base unit surplus of gas coming from the mixing of the liquid material and the solid material; and an extraction unit 204 connected to a liquid/solid mixing output 23 and extracting a solid/liquid material substantially without gas from the base unit. The separation and extraction unit has the advantage simultaneously separating and extracting surplus gas, and this separation and extraction step is performed by the same device. In a preferred embodiment, the mixing system contains a recirculation loop and the base unit is a base cyclic unit 22 ensuring recirculation in the injection unit 20 through a recirculation input 27. The recirculation ensures a continuous mixing of the slurry and therefore a better mixing efficiency. The recirculation is accomplished thanks to a pump present on the base cyclic unit 22. Preferably, the pump is located between the separation and extraction unit 24 and the extraction unit 204; the pump may be a centrifugal pump. Also, all the base unit and/or base cyclic unit have the rule of the mixing system.

The system may be used for any type of mixing involving a liquid component and a solid component that comprises intrinsic gas or entrapped air due to its geometry or its composition. Especially, the mixing system applies when the solid component is granular or in the form of a powder with natural interstitial voids containing air. The mixing system also applies when the solid component contains artificially injected air (for example, when fluidized to ensure transportation). The mixing system also applies when the liquid component and the solid component are chemically reactive or when the liquid and solid components react chemically and produce surplus gas.

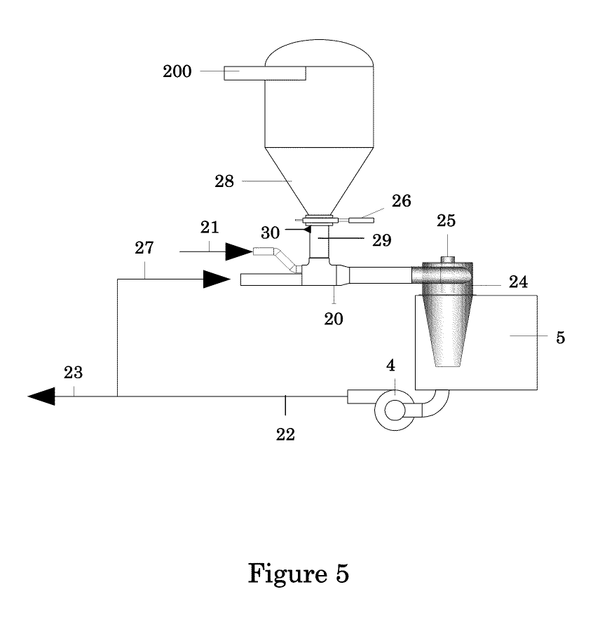

In preferred embodiments, the solid component is a dry cement blend and the liquid component is a mixing fluid that comprises water and other additives or aqueous solutions. FIG. 5 is a schematic diagram of a mixing system with a surge can 28. The solid materials are delivered to the injection unit 20 directly from the surge can 28 via a flow control valve 26. The cement is delivered to the surge can from a cement supply 200. And the mixing fluid is delivered to the injection unit from a mixing fluid supply 21. The solid materials are carried into the mixing tub 5 with the mixing fluid after have passed in a separation and extraction unit 24. The separation and extraction unit 24 separates the liquid/solid slurry content from the gas surplus. The separation and extraction unit is not entirely submerged in the mixing tub. Thus, the surplus-gas content is separated and extracted from the slurry, and simultaneously ejected to the surrounding atmosphere, via a gas-surplus output 25. The contents of the mixing tub 5 are recirculated with a pump 4 through a recirculation pipe 22 to the injection unit 20 via a recirculation input 27. The pump 4 is preferably a centrifugal pump. An output 23 is provided for slurry to be pumped into the well.

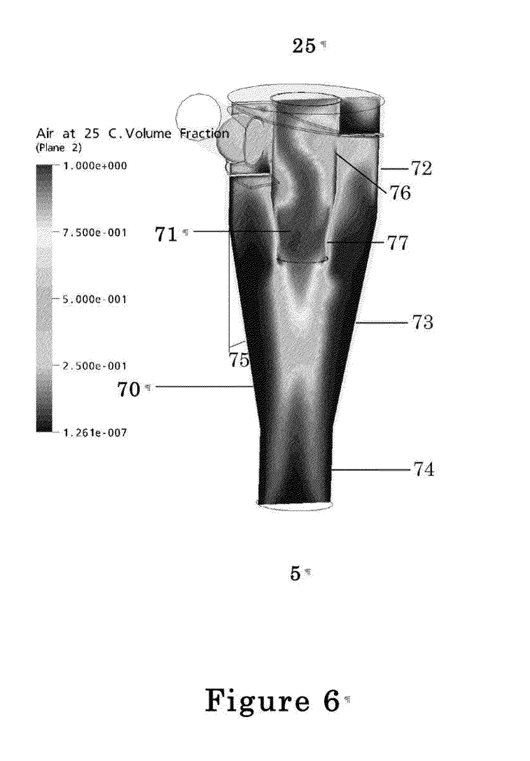

The separation and extraction unit 24 is preferably a conical cyclonic unit or a hydrocyclone system. FIG. 6 provides a schematic view of the principle of the separation and extraction unit. The conical cyclonic unit separates the liquid/solid slurry content from the gas surplus and is preferably a hydrocyclone. Using the centrifugation principle, the hydrocyclone 70, installed on the top of the mixing tub 5, separates air from liquid/solid slurry. The gas surplus output 25 is an exhaust pipe 71 in communication with the atmosphere. The exhaust pipe releases air to the atmosphere. In operation, the liquid/solid slurry is introduced into the interior of the conical hydrocyclonic unit. The tangential force inside the hydrocyclone causes the slurry to rotate at a high angular velocity, forcing heavier material (liquid/solid slurry) to the side walls where they continue downward with increasing velocity to the bottom of the conical section of the hydrocyclone. The cyclonic flow in the hydrocyclone creates a centrally located low-pressure vortex where the lighter material (surplus gas) flows upward and exits the top of the hydrocyclone through the exhaust pipe 71 as shown in FIG. 6. The hydrocyclone is a rather simple, highly efficient sizing device with no moving internal parts.

The hydrocyclone comprises: (i) an upper cylindrical section 72; (ii) a conical section 73; (iii) a lower cylindrical section 74; and (iv) an exhaust pipe 71. The diameter of the upper cylindrical section is preferably larger than the diameter of the lower cylindrical section. Thus, the hydrocyclone is preferably tapered, with a tapering angle 75 defined as the angle between the inside surface of the conical section and the longitudinal axis of the hydrocyclone. The exhaust pipe is preferably located inside the upper cylindrical section.

The length ratio between the upper cylindrical section 72 and the conical section 73 is preferably between about 0.50 and 0.90, and more preferably between about 0.50 and about 0.70. The length ratio between the upper cylindrical section 72 and the lower cylindrical section 74 is preferably between about 1.10 and about 1.70, and more preferably between about 1.50 and about 1.60. The ratio between the exhaust-pipe 71 length and the hydrocyclone length (i.e., the sum of the lengths of 72, 73 and 74) is preferably between about 0.3 and about 0.5, and more preferably between about 0.35 and about 0.45.

The tapering angle 75 is preferably between about 10° and about 15°, and more preferably between about 10.5° and about 11.5°. The inside-diameter ratio between the upper cylindrical section 72 and the lower cylindrical section 74 is preferably between about 1.90 and about 2.20, and more preferably between about 1.95 and about 2.10. The inside-diameter ratio between the upper cylindrical section 72 and the exhaust pipe 71 is preferably between about 2.0 and about 3.2, more preferably between about 2.2 and about 3.2.

Optionally, the exhaust pipe 71 may be tapered (as depicted in FIG. 6). The inside diameter of the upper portion of the pipe is preferably larger than the inside diameter of the lower portion. Under these circumstances, the length ratio between the upper portion 76 and the lower portion 77 is preferably between about 3.0 and about 3.5, and more preferably between about 3.2 and about 3.4. The inside-diameter ratio between the upper portion 76 and the lower portion 77 is preferably between about 1.0 and about 1.5, and more preferably between about 1.3 and about 1.4.

The actual dimensions of the portions that comprise the hydrocyclone are preferably chosen to accommodate the pumping of slurries at rates between about 16 L/min and 4790 L/min (0.1 bbl/min and 30 bbl/min).

A test was performed with and without the hydrocyclone before the mixing tub. When the exhaust pipe was closed (which corresponds to a mixing system without a hydrocyclone), the total volume of the slurry present in the mixing system increased—7% of the slurry volume was air. Therefore, when the hydrocyclone functions, at least 7% of the surplus gas or entrapped air in the slurry is extracted. Furthermore, it has been shown that for prior art systems, 2% of air present in the slurry decreases the centrifugal-pump efficiency by 10% (i.e., the efficiency of the mixing system), and 4% of air present in the slurry decreases the centrifugal pump efficiency by 43%. Eliminating 7% of air present in the slurry dramatically increases the efficiency of the mixing system. The mixing-system efficiency has a direct impact on the slurry quality and the mixing time. Without surplus air, the slurry is mixed more accurately and the pump functions efficiently and rapidly.

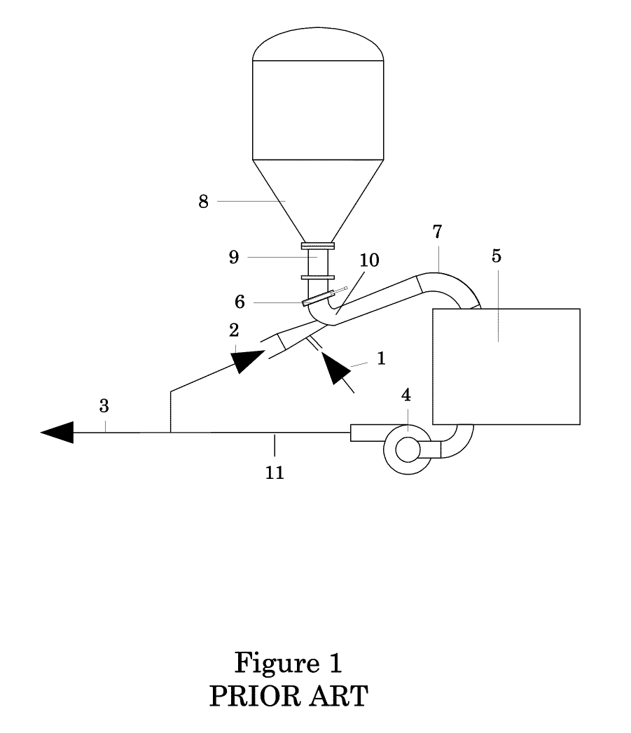

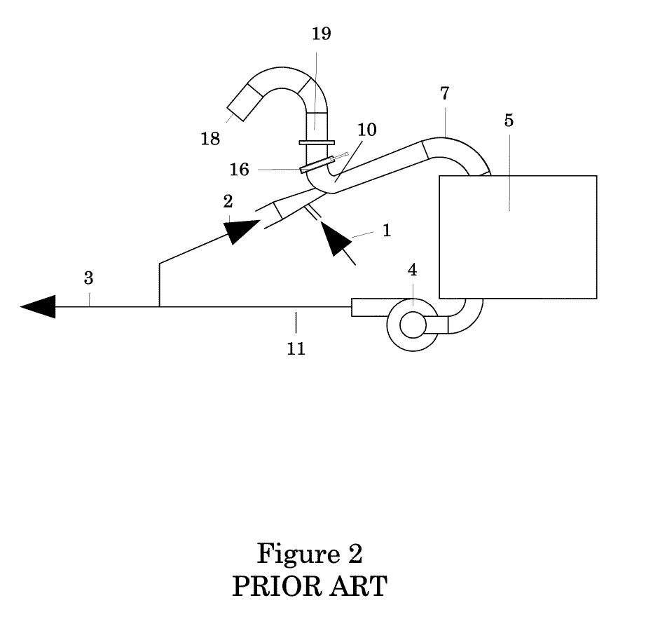

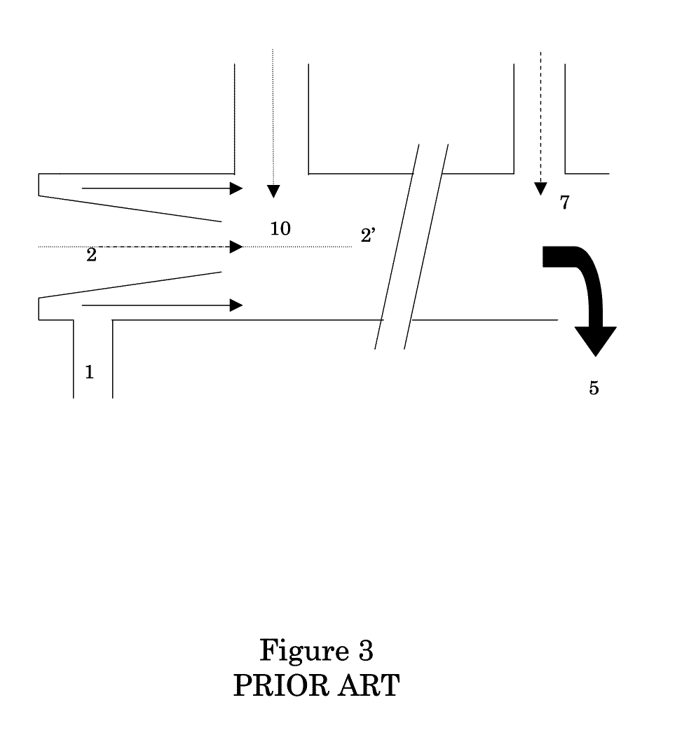

Additionally, in the mixing systems depicted by FIGS. 1 and 2 from Prior Art, another problem occurs directly in the mixer 10. The mixer of prior art is disclosed in FIG. 3. The mixer contains a recirculation input nozzle 2 and a surrounding annular nozzle for the water supply 1 which supplies respectively the liquid/solid slurry and the liquid component following an axis 2′. The solid component is delivered approximately perpendicularly to the axis 2′. Because the liquid component supply is annular, all of the liquid component cannot be mixed directly at this stage with the solid component. The annular supply does not allow a full flow. Effectively, the flow rate and the pressure being the maximum allowed for the liquid component supply 1, a part of the liquid component has to be added upstream via a second liquid supply 7 in the mixing tub 5. The mix between liquid and solid components occurs later, and therefore the mixing efficiency is reduced. Furthermore, a part of the liquid component is mixed first with the solid component and another part of the liquid component is mixed first with the liquid/solid slurry. This delay causes inefficiency in the mixing process.

Also, in preferred embodiments, the injection unit 20 further comprises the function of pre-mixing the liquid material and the solid material and more preferably the injection unit 20 is an injector with three nozzles or a T-shaped mixing bowl. To the injection unit 20, three connection inputs or nozzles are coming, respectively: the cement supply (via the tube 29), the mixing fluid supply 21 and the recirculation input 27. The system is built so that cement and mixing fluid are first mixed together before being mixed with the recirculated liquid/solid slurry. The nozzle of the mixing-fluid supply is substantially perpendicular to the nozzle of the cement supply. The recirculation nozzle is also substantially perpendicular to the cement-supply nozzle, and is located below the mixing-fluid-supply nozzle. Therefore, when the cement blend falls into the mixer, the cement blend is first in contact with mixing fluid and then with liquid/solid slurry. Unlike prior-art systems, there is no need to add a second mixing-fluid supply, because all of the mixing fluid can be delivered efficiently at this location. The mixing of the three components (cement, mixing fluid and liquid/solid slurry) is efficiently realized thanks to this input configuration. The efficiency of the mixer has a direct impact on the job quality and job performance.

Additionally, in the prior-art mixing systems as shown in FIGS. 1 and 2, another problem occurs just before the mixer 10 at the position of the valve 6 for the cement silo or valve 16 for the surge can. Due to the architecture problem and the position of the valve close to the liquid supply, the mixer is often blocked with dry solid or plugged with liquid/solid slurry. When the surrounding region (tube 9 and mixer 10) of the valve is completely blocked and cannot ensure an efficient mixing process, the mixing system has to be dismantled to clean and remove the solid content blocking the apparatus. Mostly, this operation is costly, time consuming and especially not ecological. Effectively, when the tube 9 and the mixer 10 have to be cleaned from blocked “non-green” cement on a field location, generally the cement is emptied out of the mixer into the earth surface soiling the ground water. Furthermore, because dry solid or liquid/solid slurry blocked the exit of the valve, the predefined flow rate of the valve is changed. This change in the flow rate of the valve remains uncontrollable and independent of the solid component delivery.

Also, in preferred embodiments, the dry cement is delivered to the injection unit 20 via the flow control valve 26. Between the flow-control valve and the mixer, a tube 29 is present, said tube has a length substantially great to correctly deliver the cement and allow effective mixing in the mixer 20. As said previously, the problem of prior-art mixers is that the exit of the flow-control valve remains blocked with dry cement or plugged with liquid/solid slurry. By increasing the distance between the flow control valve and the mixer, the probability of having a blocked valve decreases. The distance is sufficiently great to avoid splash coming from the mixer and flow control valve remains substantially dry. The tube 29 further comprises a pressure valve or vacuum breaker 30 located close to the flow control valve 26 and the pressure valve being in communication with surrounding atmosphere. The pressure valve allows emptying the tube correctly when the flow-control valve is closed, avoids de-pressurization of the mixer when the flow-control valve is closed and ensures a substantially constant pressure inside the tube. For example, when the flow-control valve is open with a certain flow rate, the pressure valve is closed and the dry cement falls in the mixer 20. When the flow control valve is closed, the pressure inside the tube is not sufficient, the valve opens and the remaining cement present in the tube 29 falls in the mixer 20, whereas the tube is filled with air. The tube remains clean and no dry cement or liquid/solid slurry blocks the tube and furthermore, the tube remains dry because no depressurization of the mixer has occurred and no condensation has appeared on the surfaces of the tube. Those skilled in the art will appreciate that, thanks to the cyclonic unit 24, the air present in the tube is not a problem and will be extracted from the slurry. In a preferred embodiment the flow-control valve is a knife gate or slide gate. The knife gate allows better regulation of the flow of dry cement blend. Effectively, the cement-blend rate is constant, repeatable and independent of other parameters during the mixing process for a given opening of the knife gate. So, the knife gate has a constant and repeatable behavior. The tube is preferably transparent to allow control when the cement falls in the mixer and flexible to ensure easy removing. This new configuration of the flow-control valve enhances the mixing efficiency. The efficiency of the mixer has a direct impact on the job quality and job performance (because the tube is not often blocked).

Also, in further preferred embodiments the injection unit comprises a perturbing system enhancing the delivery of the solid material. The perturbing system is located between the solid-material supply and the injection unit, or close to the solid-material supply or close to the injection unit (not shown on Figures). The perturbing system can be any type of device generating vibrations—including (but not limited to) pneumatic vibration systems, mechanical vibration systems, acoustic vibration systems, piezoelectric vibration systems and electromagnetic vibration systems. The perturbing device creates vibration with a given amplitude (force) and frequency which are communicated to the mixer: especially the injection unit, and/or the solid material supply. In a preferred embodiment, the device is a pneumatic impact vibrator mounted outside on the injection input, which operates by cycles. Force and frequency of the impact break slurry clogs if already formed, or prevent their formation if not formed.

The extraction unit 204 is preferably an output line taken in the recirculation pipe 2. The output line can be optionally comprise a pump and a flow meter. The output line delivers the cement slurry for operation in the well (not shown).

The mixing system may further comprise other devices not shown. For example, control of the slurry mixture may be achieved by controlling the density in the mixing tub with a densitometer. The densitometer is typically a non-radioactive device such as a Coriolis meter. A device for measuring the amount of liquid material or liquid/solid slurry can be added as a flowmeter, a level sensor or a load sensor. Other pumps may be added to the mixing system to ensure transportation of liquid material or liquid/solid mixture. Other valves or flow control units can also be added to the mixing system.

In further embodiments, the mixing system may be easily automated. Effectively, because the proposed mixing system solves problems of prior-art systems regarding air and cement blocking in the mixer or close to the flow-control valve, the mixing process is simpler, and unpredictable events will no longer occur. It has been noted that the knife gate has a constant and repeatable behavior. Therefore, a control device can be implemented to monitor the input of the flow rate of the solid material and the liquid material depending on the output of the flow rate of the liquid/solid slurry extracted. Alternatively, other parameters may be utilized for the monitoring as the liquid/solid slurry for recirculation, the gas surplus extracted, and the flow rate in the recirculation pipe depending on the pump 4.

The cement silo may further be replaced by several silos, each silo communicating with the control valve 26 when several solid components have to be mixed together. In the same way, the liquid supply can be replaced by several liquid supplies when several liquid components have to be mixed together. Or alternatively, mixing systems can be mounted in series. For example, when two solid components with a liquid component have to be mixed, two mixing system are mounted in series, each silo containing one of the solid components.

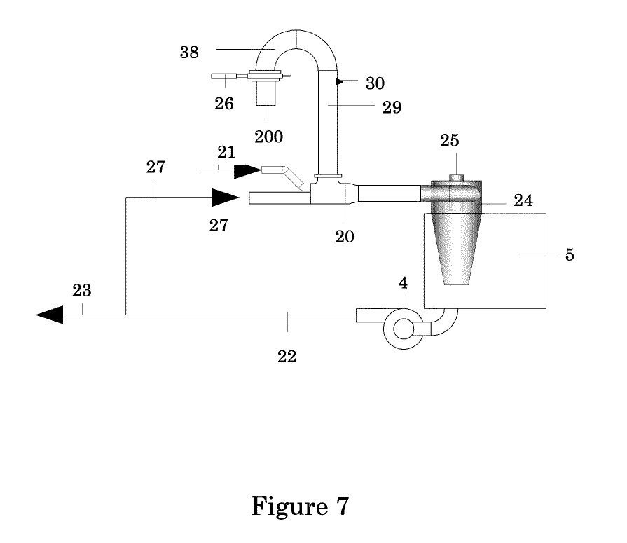

FIG. 7 is a schematic diagram of a mixing system with a direct feeding 38 or cement silo. The solid materials are delivered to the injection unit 20 directly from a cement supply 200 via a flow-control valve 26. And the mixing fluid is delivered to the injection unit from a mixing fluid supply 21. The solid materials are carried into the mixing tub 5 with the mixing fluid after have passed in a cyclonic separation unit 24. The cyclonic unit 24 separates the liquid/solid slurry content from the gas surplus. The gas surplus content is extracted from the slurry and ejected to the surrounding atmosphere via a gas surplus output 25. The contents of the mixing tub 5 are recirculated with a pump 4 through a recirculation pipe 22 to the injection unit 20 via a recirculation input 27. The pump 4 is preferably a centrifugal pump. An output 23 is provided for slurry to be pumped into the well. The embodiments already disclosed for the mixing system with a surge can apply also for this mixing system with a direct feeding.

In further aspects, embodiments relate to methods for mixing a slurry comprising a liquid material and a solid material. The operations in the mixing process comprise providing the liquid material and the solid material; placing the liquid material and the solid material into the mixing system described by earlier embodiments and operating the mixing system, thereby forming a slurry. During the mixing process, surplus gas is simultaneously separated and extracted, providing a slurry that is substantially gas free.

The mixing process may further comprise a recirculation step. The recirculation ensures a continuous mixing of the slurry and therefore a better mixing efficiency. The method is directly applied to the mixing system described above.

In yet further aspects, embodiments relate to methods for cementing a subterranean well. The methods comprise preparing a cement slurry in the mixing system described by earlier embodiments and pumping the cement slurry into the subterranean well. The slurry comprises a solid cement and water. During the mixing process, surplus gas is simultaneously separated and extracted, providing a slurry that is substantially gas free. Those skilled in the art will recognize that a pumpable cement slurry usually has a viscosity lower than 1000 mPa-s at a shear rate of 100 s⁻1.

The cement is preferably an inorganic cement. Inorganic cements comprise (but are not limited to) Portland cement, calcium aluminate cement, lime/silica blends, blast furnace slag, fly ash, Sorel cements, chemically bonded phosphate ceramics and geopolymers.

The solid cement may further comprise solid additives blended therein. Such additives may comprise (but would not be limited to) accelerators, retarders, extenders, weighting agents, fluid-loss additives, lost-circulation additives, gas-generating agents and antifoam agents. The water may also contain similar additives dissolved or dispersed therein.

1. A system for mixing a liquid material and a solid material, the system comprising:
(i) a base unit for mixing the liquid material and the solid material;
(ii) a liquid material supply;
(iii) a solid material supply;
(iv) a liquid/solid mixing output;
(v) an injection unit connected to the liquid material supply and to the solid material supply, the injection unit injecting the liquid material and the solid material into the base unit; and
(vi) a separation and extraction unit comprising a hydrocyclone, the hydrocyclone comprising a conical cyclone inside which surplus gas arising from the mixing of the liquid material and the solid material is extracted from the base unit, the separation and extraction unit being directly open to the atmosphere.

2. The system of claim 1, wherein the conical cyclone comprises:
(i) an upper cylindrical section;
(ii) a lower cylindrical section;
(ii) a conical section between the upper and lower cylindrical sections; and
(iv) an exhaust pipe,
wherein the diameter of the lower cylindrical section is smaller than the diameter of the upper cylindrical section, and a tapering angle is defined as the angle between the inside surface of the conical section and the longitudinal axis of the hydrocyclone;
wherein the exhaust pipe is located inside the upper cylindrical section; and
wherein the length of the hydrocyclone is defined as the sum of the lengths of the upper cylindrical section, the lower cylindrical section and the conical section.

3. The system of claim 2, wherein:
(i) the length ratio between the upper cylindrical section and the conical section is between about 0.50 and about 0.90;
(ii) the length ratio between the upper cylindrical section and the lower cylindrical section is between about 1.10 and about 1.70;
(iii) the length ratio between the exhaust pipe and the hydrocyclone is between about 0.3 and about 0.5;
(iv) the inside-diameter ratio between the upper cylindrical section and the lower cylindrical section is between about 1.90 and about 2.20;
(v) the inside-diameter ratio between the upper cylindrical section and the exhaust pipe is between about 2.0 and 3.2; and
(vi) the tapering angle is between about 10° and 15°.

4. The system of claim 2, wherein:
(i) the exhaust pipe is tapered;
(ii) the inside diameter of the upper portion of the pipe is larger than the diameter of the lower portion;
(iii) the length ratio between the upper portion and the lower portion is between about 3.0 and about 3.5; and
(iv) the inside-diameter ratio between the upper portion and the lower portion being between about 1.0 and about 1.5.

5. The system of claim 1, wherein the base unit is a base cyclic unit through which liquid material and solid material may recirculate.

6. The system of claim 1, wherein the injection unit comprises an injector with three nozzles:
(i) a solid material supply nozzle through which dry solid materials flow;
(ii) a mixing fluid supply nozzle through which liquid materials flow; and
(iii) a recirculation input nozzle through which a mixture of the solid materials and the liquid materials flow,
wherein, the solid material supply nozzle and the mixing fluid supply nozzle allow a first mixing before a second mixing through the recirculation input nozzle.

7. The system of claim 1, further comprising a control system controlling the solid material supply, the control system being located at a distance longer than about 5 cm from the injection unit.

8. The system of claim 7, wherein a tube is located between the control system and the injection unit.

9. The system of claim 7, further comprising a pressure valve located between the control system and the injection unit.

10. The system of claim 1, wherein the mixing system is an automated system with a control device, the control device controlling the solid material supply.

11. The system of claim 1, further comprising a perturbing system between the solid material supply and the injection unit, wherein the perturbing system is any member of the list comprising: a pneumatic vibration system, an acoustic vibration system, a piezoelectric vibration system and an electromagnetic vibration system.

12. A method for mixing a liquid material and a solid material, comprising:
(i) providing the liquid material and the solid material;
(ii) placing the liquid material and the solid material into a mixing system, the mixing system comprising:
(a) a base unit for mixing the liquid material and the solid material;
(b) a liquid material supply;
(c) a solid material supply;
(d) a liquid/solid mixing output;
(e) an injection unit connected to the liquid material supply and to the solid material supply, the injection unit injecting the liquid material and the solid material into the base unit; and
(f) a separation and extraction unit comprising a hydrocyclone, the hydrocyclone comprising a conical cyclone inside which surplus gas arising from the mixing of the liquid material and the solid material is extracted from the base unit, the separation and extraction unit being directly open to the atmosphere;
(iii) operating the mixing system, thereby forming a slurry;
wherein, surplus gas is simultaneously separated and extracted from the slurry, thereby providing a slurry that is substantially gas free.

13. The method of claim 12, wherein the conical cyclone comprises:
(i) an upper cylindrical section;
(ii) a lower cylindrical section;
(ii) a conical section between the upper and lower cylindrical sections; and
(iv) an exhaust pipe,
wherein the diameter of the lower cylindrical section is smaller than the diameter of the upper cylindrical section, and a tapering angle is defined as the angle between the inside surface of the conical section and the longitudinal axis of the hydrocyclone; and
wherein the exhaust pipe is located inside the upper cylindrical section; and
wherein the length of the hydro cyclone is defined as the sum of the lengths of the upper cylindrical section, the lower cylindrical section and the conical section.

14. The method of claim 13, wherein:
(i) the exhaust pipe is tapered;
(ii) the inside diameter of the upper portion of the pipe is larger than the diameter of the lower portion;
(iii) the length ratio between the upper portion and the lower portion is between about 3.0 and about 3.5; and
(iv) the inside-diameter ratio between the upper portion and the lower portion being between about 1.0 and about 1.5.

15. The system of claim 12, wherein the base unit is a base cyclic unit through which liquid material and solid material may recirculate.

16. The system of claim 12, wherein the injection unit comprises an injector with three nozzles:
(i) a solid material supply nozzle through which dry solid materials flow;
(ii) a mixing fluid supply nozzle through which liquid materials flow; and
(iii) a recirculation input nozzle through which a mixture of the solid materials and the liquid materials flow,
wherein, the solid material supply nozzle and the mixing fluid supply nozzle allow a first mixing before a second mixing through the recirculation input nozzle.

17. A method for cementing a subterranean well, comprising:
(i) preparing a cement slurry in a mixing system, the slurry comprising a solid cement and water, wherein the mixing system comprises:
(a) a base unit for mixing the liquid material and the solid material;
(b) a solid cement supply;
(c) a water supply;
(d) a liquid/solid mixing output;
(e) an injection unit connected to the liquid material supply and to the solid material supply, the injection unit injecting the liquid material and the solid material into the base unit; and
(f) a separation and extraction unit comprising a hydrocyclone, the hydrocyclone comprising a conical cyclone inside which surplus gas arising from the mixing of the liquid material and the solid material is extracted from the base unit, the separation and extraction unit being directly open to the atmosphere;
(ii) pumping the cement slurry into the subterranean well.

18. The method of claim 16, wherein the conical cyclone comprises:
(i) an upper cylindrical section;
(ii) a lower cylindrical section;
(ii) a conical section between the upper and lower cylindrical sections; and
(iv) an exhaust pipe,
wherein the diameter of the lower cylindrical section is smaller than the diameter of the upper cylindrical section, and a tapering angle is defined as the angle between the inside surface of the conical section and the longitudinal axis of the hydrocyclone; and
wherein the exhaust pipe is located inside the upper cylindrical section; and
wherein the length of the hydro cyclone is defined as the sum of the lengths of the upper cylindrical section, the lower cylindrical section and the conical section.

19. The method of claim 16, wherein:
(i) the exhaust pipe is tapered;
(ii) the inside diameter of the upper portion of the pipe is larger than the diameter of the lower portion;
(iii) the length ratio between the upper portion and the lower portion is between about 3.0 and about 3.5; and
(iv) the inside-diameter ratio between the upper portion and the lower portion being between about 1.0 and about 1.5.

20. The system of claim 16, wherein the base unit is a base cyclic unit through which liquid material and solid material may recirculate.
